(19) United States
(12) Patent Application Publication
(10) Pub. No.: US 2016/0103230 A1
(43) Pub. Date: Apr. 14, 2016

(54) APPARATUS AND METHOD FOR MEASURING ALPHA RADIATION FROM LIQUIDS

(71) Applicant: Honeywell International Inc., Morristown, NJ (US)

(72) Inventor: Brett M. Clark, Spokane Valley, WA (US)

(21) Appl. No.: 14/819,285

(22) Filed: Aug. 5, 2015

Related U.S. Application Data
(60) Provisional application No. 62/063,049, filed on Oct. 13, 2014.

(51) Int. Cl. G01T 1/178; G01T 7/00

(52) U.S. Cl. CPC G01T 1/178; G01T 7/00

(57) ABSTRACT

An apparatus and an analytical method for detecting and measuring alpha particle emissions from liquid samples using direct detectors. The apparatus may include a partition that is vapor-impermeable and alpha-permeable such that vapor from the liquid sample is substantially or entirely prevented from escaping through the partition, while alpha particles are able to escape through the partition for detection. The method may offer improved accuracy, flexibility, and quality in detecting and measuring alpha particle emissions.

### CROSS REFERENCE TO RELATED APPLICATION

This application claims the benefit under Title 35, U.S.C. §119(e) of U.S. Provisional Patent Application Ser. No. 62/063,049, entitled APPARATUS AND METHOD FOR MEASURING ALPHA RADIATION FROM LIQUIDS, filed on Oct. 13, 2014, the entire disclosure of which is expressly incorporated by reference herein.

### FIELD OF THE INVENTION

The present disclosure relates to alpha particle emissions, and in particular, the present disclosure relates to an apparatus and an analytical method for measuring alpha particle emissions from liquid samples.

### DESCRIPTION OF THE RELATED ART

Metallic materials, such as pure metals and metal alloys, for example, are typically used as solders in many electronic device packaging and other electronic manufacturing applications. It is well known that the emission of alpha particles from certain isotopes may lead to single-event upsets (“SEUs”), often referred to as soft errors or soft error upsets. Alpha particle emission (also referred to as alpha flux) can cause damage to packaged electronic devices, and more particularly, can cause soft error upsets and even electronic device failure in certain cases. Concerns regarding potential alpha particle emission heighten as electronic device sizes are reduced and alpha particle emitting metallic materials are located in closer proximity to potentially sensitive locations.

Initial research surrounding alpha particle emission from metallic materials focused on lead-based solders used in electronic device applications and consequent efforts to improve the purity of such lead-based solders. Of particular concern is the uranium-238 (²³⁸U) decay chain, in which ²³⁸U decays to lead-210 (²¹⁰Pb), ²¹⁰Pb decays to bismuth-210 (²¹⁰Bi), ²¹⁰Bi decays to polonium-210 (²¹⁰Po) and ²¹⁰Po decays to lead-206(²⁰⁶Pb) with release of a 5.304 MeV alpha particle. It is the last step of this decay chain, namely, the decay of ²¹⁰Po to ²⁰⁶Pb with release of an alpha particle, which is considered to be the primary alpha particle emitter responsible for soft error upsets in electronic device applications.

More recently, there has been a transition to the use of non-lead or “lead free” metallic materials, such as silver, tin, copper, bismuth, aluminum, and nickel, for example, either as alloys or as pure elemental materials. However, even in substantially pure non-lead metallic materials, lead is typically present as an impurity. Such materials are often refined to minimize the amount of lead impurities in the materials, but even very low levels (e.g., less than parts per trillion by mass) of lead impurities may be potentially problematic in the context of alpha particle emissions.

Due to the risk of damage associated with alpha particle emissions, it is often necessary to use an alpha particle detector to test alpha particle emission levels from a selected metallic material. Depending on the outcome of the test, one may determine whether the metallic material is suitable for use in electronic manufacturing applications or other applications.

A first type of alpha particle detector is a direct detector. As used herein, a “direct detector” measures electrical charge created from radiation interactions in an active volume of the detector. An exemplary direct detector is a gas flow counter, for example, which measures electrically charged electron-ion pairs produced by radiation ionization of counting gas molecules in the active volume of the detector. Advantageously, direct detectors are able to distinguish signals from sample radiation from most background radiation (i.e., noise), including background radiation from cosmic rays, to offer improved sensitivity with an increased signal to noise ratio. However, current state of the art direct detectors are limited to use with solid samples, not liquid samples.

In solid samples, only those alpha particles emitted close to the surface of the solid sample are capable of traveling through the solid sample and reaching the active volume of the detector for detection. In the case of a solid lead or tin sample, for example, only those ²¹⁰Po alpha particles emitted within about 15-17 microns of the surface will be detected. Alpha particles emitted further within the sample than the range in the material will not be detected.

In liquid samples, by contrast, alpha particles are capable of traveling a greater distance for detection. In the case of a water-based or isopropyl alcohol-based sample, for example, ²¹⁰Po alpha particles emitted within about 40 microns of the surface may be detected. However, liquid samples have not traditionally been compatible with direct detectors, because water vapor or other electronegative impurities in the counting gas change electron drift velocity and reduce the amount of charge generated by the event. Therefore, direct detectors are taught to operate in dry conditions.

A second type of alpha particle detector is an indirect detector. As used herein, an “indirect detector” measures light pulses generated from the radiation interacting with a scintillation material. An exemplary indirect detector is a liquid scintillation counter, for example, which measures electromagnetic radiation produced from radiation striking a scintillator material. Although liquid scintillation counters are compatible with liquid samples, indirect detectors generally operate in ambient conditions and detect about 100 to 1,000 times more background radiation than the above-described direct detectors. For this reason, indirect detectors lack the sensitivity required to measure low levels of alpha particle emissions. Their indirect nature also subjects indirect detectors to inherent efficiency and interference concerns.

What is needed is an apparatus and an analytical method for more accurately detecting and measuring alpha particle emissions from liquid samples, particularly below ambient background levels.

### SUMMARY OF THE INVENTION

The present disclosure provides an apparatus and an analytical method for detecting and measuring alpha particle emissions from liquid samples using direct detectors. The apparatus may include a partition that is vapor-impermeable and alpha-permeable such that vapor from the liquid sample is substantially or entirely prevented from escaping through the partition, while alpha particles are able to escape through the partition for detection. The ability to test liquid samples allows for the detection of alpha particles over greater distances than solid samples for more accurate detection. Also, the ability to test liquid samples provides flexibility and breadth in selecting the sample medium. The ability to use direct detectors offers reduced background and improved sensitivity compared to indirect detectors. Thus, the present disclosure provides for improved accuracy, flexibility, and quality in detecting and measuring alpha particle emissions.

In one form thereof, the present disclosure provides a method of measuring an alpha particle emission level from a liquid sample. The method includes the steps of placing the liquid sample in a holder having a partition, the partition being impermeable to vapor from the liquid sample and permeable to alpha particles from the liquid sample, and using a detector to measure the alpha particle emission level of the liquid sample.

In another form thereof, the present disclosure provides a sample holder for use with an alpha particle detector. The sample holder includes a base that defines a tub for receiving a liquid sample, the base being sized for receipt in the alpha particle detector, and a partition located between the tub and the alpha particle detector, the partition being impermeable to vapor from the liquid sample in the tub and permeable to alpha particles from the liquid sample in the tub.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a perspective view of an exemplary sample holder of the present disclosure, shown with a partition covering an interior tub of the sample holder;

FIG. 2 is a top plan view of the sample holder of FIG. 1;

FIG. 3 is a cross-sectional view of the sample holder of FIG. 2, taken along line 3-3 of FIG. 2;

FIG. 3A is a detailed view of the circled portion of FIG. 3;

FIG. 4 is another perspective view of the sample holder, shown with the partition removed to expose the interior tub of the sample holder;

FIG. 5 is an elevational view of the sample holder of FIG. 4;

FIG. 6 is a top plan view of the sample holder of FIG. 4;

FIG. 7 is a cross-sectional view of the sample holder of FIG. 6, taken along line 7-7 of FIG. 6;

FIG. 7A is a detailed view of the circled portion of FIG. 7;

FIG. 8 is another cross-sectional view of the sample holder of FIG. 6, taken along line 8-8 of FIG. 6;

FIG. 8A is a detailed view of the circled portion of FIG. 8;

FIG. 9 is another cross-sectional view of the sample holder of FIG. 6, taken along line 9-9 of FIG. 6;

FIG. 10 is a top plan view of a spacer for use with the sample holder;

FIG. 11 is a top plan view of the sample holder, shown with a temporary support in place to support the partition;

FIG. 12 is a cross-sectional view of the sample holder and the temporary support of FIG. 11, taken along line 12-12 of FIG. 11;

FIG. 13 is a schematic view of an exemplary alpha particle detector used to measure alpha particle emission levels from a sample in the sample holder;

FIGS. 14A-14C are graphs of experimental alpha particle detection data for a dry sample; and

FIGS. 15A-15C are graphs of experimental alpha particle detection data for a wet sample.

### DETAILED DESCRIPTION

The present disclosure provides an apparatus and an analytical method for measuring alpha particle emissions from liquid samples. In addition to electronic device applications, the present disclosure may be applicable to chemical applications, electrodeposition applications, refining applications, and other applications for measuring alpha emitting isotopes below ambient levels.

The following description principally relates to the ²³⁸U decay chain by which ²¹⁰Po is the primary alpha particle emitter. However, the present method may also be used to assess alpha particle emission from one or more isotopes other than ²¹⁰Po formed from the ²³⁸U decay chain.

An exemplary analytical method of the present disclosure involves (1) preparing a liquid sample, (2) placing the liquid sample in a partitioned sample holder, and (3) placing the partitioned sample holder in a direct detector for alpha particle detection. Each step of this exemplary method is described further below.

### Liquid Sample

A liquid sample is prepared including a metallic material to be tested and a liquid solvent. The metallic material may be added to the liquid solvent manually and intentionally for testing, or the metallic material may be already present in the liquid solvent for testing. The metallic material may be dissolved or suspended in the liquid solvent.

In embodiments where the metallic material is added to the liquid solvent, the form in which the metallic material is added to the liquid solvent may vary. For example, the metallic material may be added to the liquid solvent in the form of an ingot or a powder. The process of adding the metallic material to the liquid solvent may be facilitated by heating the liquid solvent and/or agitating (e.g., stirring) the liquid solvent.

The concentration of the metallic material in the liquid solvent may also vary. For example, the liquid sample may include about 20, 40, 60, 80, or 100 grams of the metallic material per liter of the liquid solvent (g/L). It is also within the scope of the present disclosure that the liquid sample may contain low or trace amounts of the metallic material. For example, the liquid sample may contain less than parts per million by mass or parts per trillion by mass of the metallic material.

The metallic material to be tested may be a single or substantially pure elemental material, such as tin, lead, copper, aluminum, bismuth, silver, and nickel, for example. The metallic material may also be an alloy of any two or more of the foregoing materials or an alloy of any one or more of the foregoing materials with one or more other elements.

The liquid solvent may include water (e.g., deionized water), an acidic solvent (e.g., hydrochloric acid, sulfuric acid), a basic solvent (e.g., aqueous sodium hydroxide), an organic solvent (e.g., isopropyl alcohol), or other suitable solvents.

In one embodiment, the liquid sample is made by adding to a liquid solvent a high-purity metallic material (e.g., tin) that is intended for use in the manufacture of electronic components, such as for solders in electronic device packaging applications. The metallic material may be added to the liquid solvent in the form of an ingot or a powder, for example. Because the metallic material will become dissolved or suspended in the liquid solvent, it may be unnecessary to process the metallic material into a smooth, thin sheet before subjecting the metallic material to alpha particle detection.

In another embodiment, the liquid sample is a refining solution containing a high-purity metallic material (e.g., tin) in a liquid solvent (e.g., sulfuric acid). The ability to subject the metallic material to alpha particle detection in its existing liquid state may eliminate the need to process or prepare the refining solution for detection. In other words, the refining solution may be subjected to detection in the same liquid state that it is used commercially.

In yet another embodiment, the liquid sample is an electrochemical plating bath containing a high-purity metallic material (e.g., tin) in a liquid solvent (e.g., hydrochloric acid). The ability to subject the metallic material to alpha particle detection in its existing liquid state may eliminate the need to process or prepare the plating bath for detection. In other words, the plating bath may be subjected to detection in the same liquid state that it is used commercially.

In yet another embodiment, the liquid sample is a substantially pure water solution containing radioisotopes below standard analytical method detection limits. The ability to subject the water solution to alpha particle detection in its existing liquid state may eliminate the need to process or prepare the water solution for detection. Also, the ability to subject the water solution to direct detection may allow one to distinguish even trace levels of radioisotopes in the water solution from ambient background levels.

### Partitioned Sample Holder

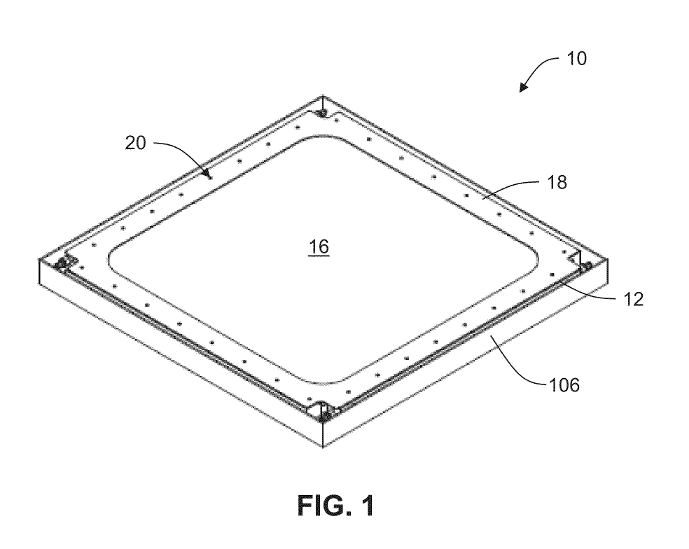

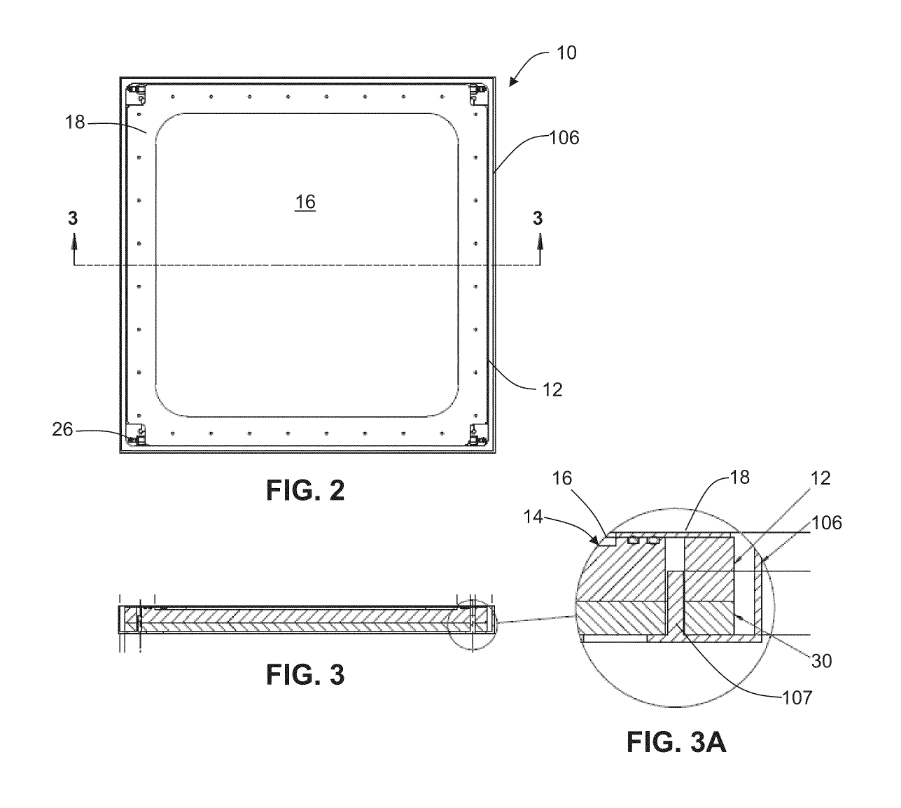

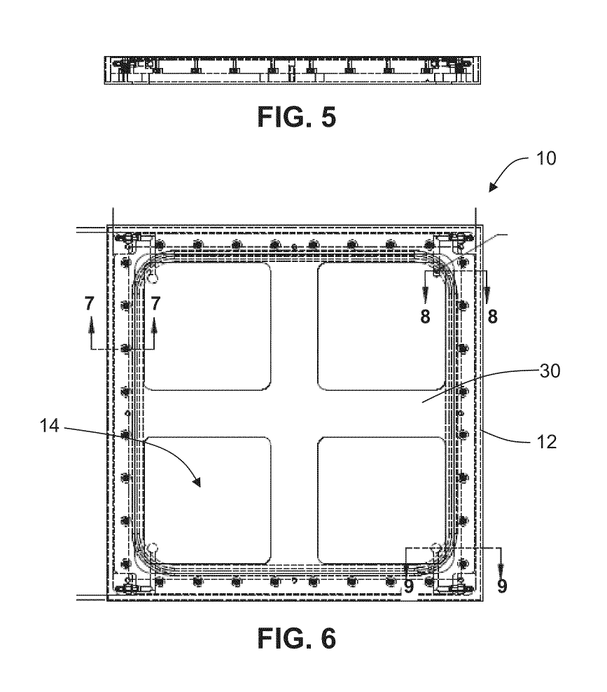

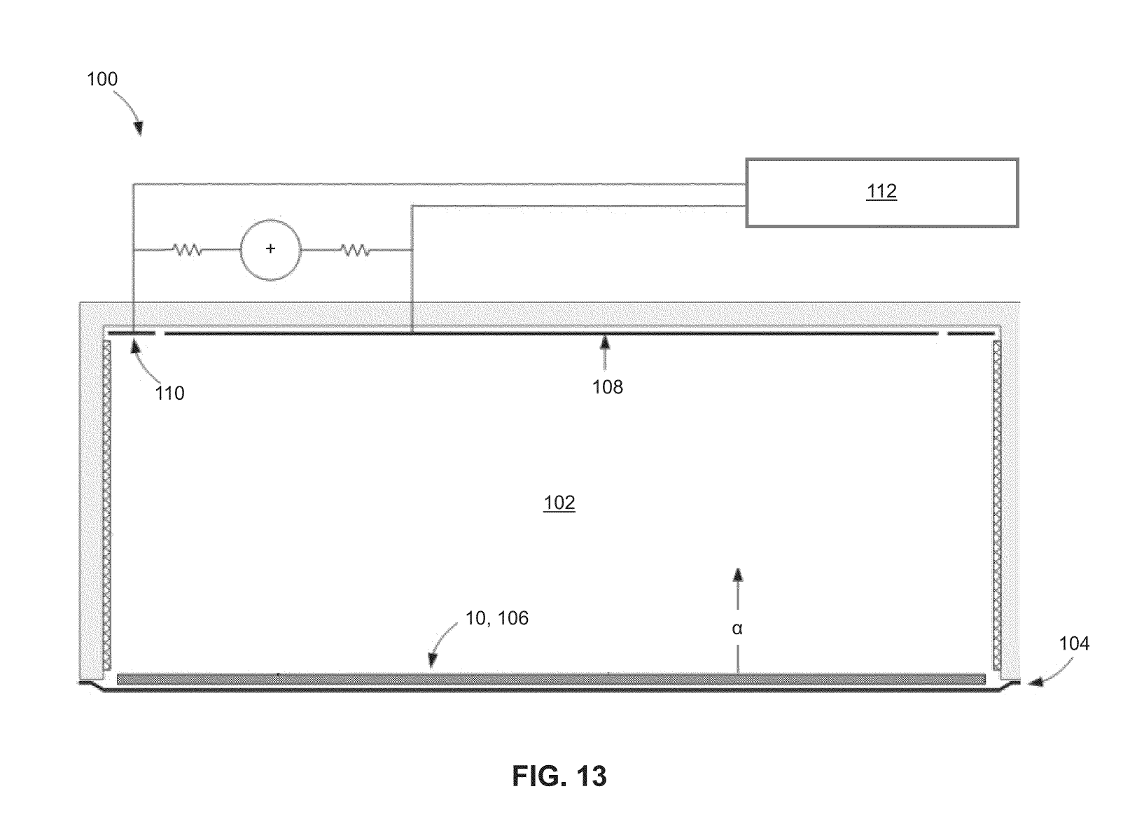

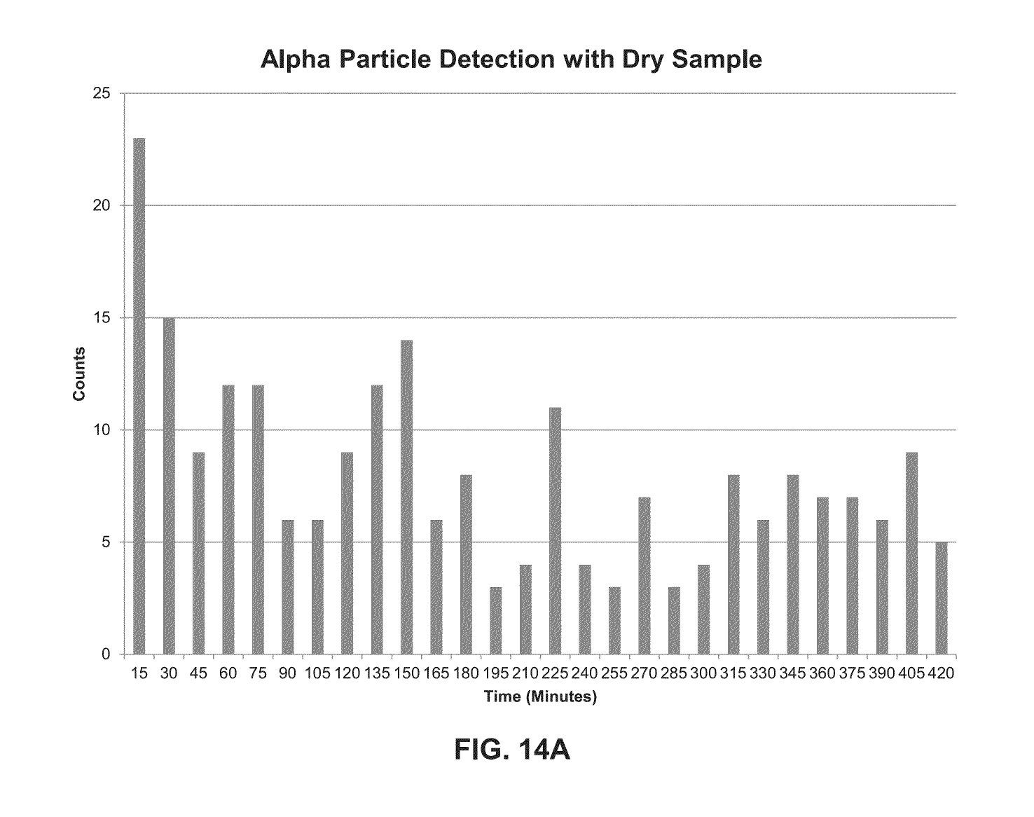

The liquid sample may be placed inside a partitioned sample holder 10. An exemplary sample holder 10 is shown in FIGS. 1-12. Sample holder 10 includes a base 12. An exemplary base 12 is constructed of a conductive material, such as a conductive, high density, ultra-high molecular weight (UHMW) plastic material, or another suitable material. Base 12 may be sized and shaped to fit within a tray 106 of an alpha particle detector 100, which is described further below (See FIG. 13). Base 12 of the illustrative sample holder 10 is a square-shaped container having a width of about 23″, a length of about 23″, and a thickness of about 1″ to fit within a corresponding square-shaped tray 106, although the dimensions of base 12 may vary to accommodate different trays 106 and different alpha particle detectors 100, for example. Base 12 may interact with tray 106 to limit movement therebetween. For example, in the illustrated embodiment of FIG. 3A, the underside of base 12 receives a stabilizing post 107 from tray 106 to limit movement between base 12 and tray 106.

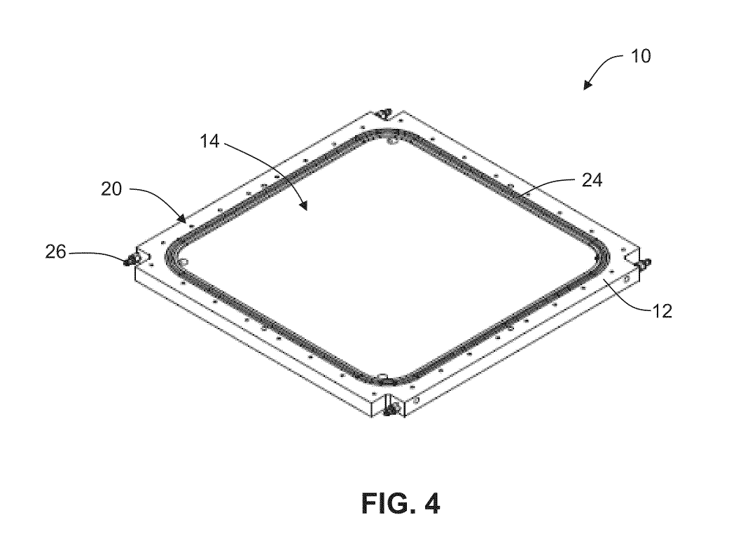

Base 12 defines a recess or tub 14 that is configured to receive and hold the liquid sample, as shown in FIGS. 4-6. Tub 14 of the illustrative sample holder 10 is a square-shaped recess having a width of about 19″, a length of about 19″, and a thickness of about ⅛″, although the dimensions of tub 14 may vary to accommodate different types and amounts of liquid samples.

Sample holder 10 also includes a partition 16 that is sized and shaped to cover tub 14 and to separate tub 14 from an active volume 102 of detector 100, as shown in FIGS. 1-3. Partition 16 behaves as a window, preventing some material from passing through partition 16 while allowing other material to pass through partition 16. Specifically, partition 16 of the present disclosure is a vapor-impermeable (i.e., a vapor barrier) window and an alpha-permeable window. In this manner, vapor in tub 14 is substantially or entirely prevented from escaping from tub 14 through partition 16, while alpha particles are able to escape from tub 14 through partition 16. Constructing partition 16 of a polypropylene (PP) film, a polyethylene (PE) film, a mylar film, or another film may provide a suitable vapor barrier. To function correctly in detector 100, at least the surface of partition 16 that will be oriented toward active volume 102 of detector 100 must be conductive. For example, partition 16 may be constructed of a metallized (e.g., aluminized) PP film, such as the B(17) Coated Film available from AVR Instrument Grade Films of Northfield, Mass., where at least the upper surface of partition 16 is metallized and conductive. Also, the thickness of partition 16 may be minimized to encourage alpha-permeability. For example, partition 16 may have a thickness less than about 10 microns, 8 microns, 6 microns, 4 microns, 2 microns, or less. The above-mentioned B(17) Coated Film has a thickness of about 6 microns (0.00024″). Another exemplary material that may be used to construct partition 16 is graphene, which is generally thin (e.g., about one atom thick), strong, nearly transparent, and conductive. Graphene films have been described in literature (See, e.g., Bae, S. et al., “Roll-to-roll production of 30-inch graphene films for transparent electrodes,” Nature Nanotechnology 5,574-578 (2010), available online at http://www.nature.com/nnano/journal/v5/n8/full/nnano.2010.132.html).

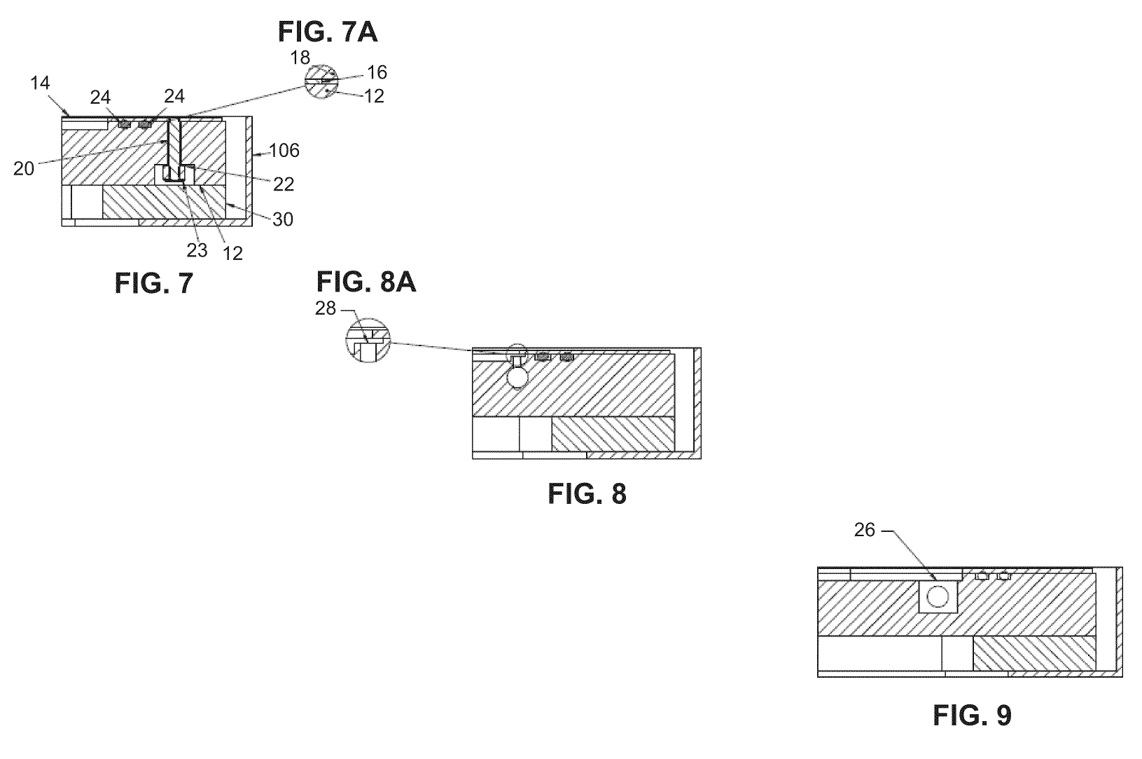

Sample holder 10 further includes a retaining ring 18 that holds partition 16 in place against base 12, as shown in FIGS. 1-3. Retaining ring 18 may be in the shape of an empty frame, such that retaining ring 18 interacts with the outer region or rim of partition 16 that sits atop the outer region or rim of base 12 without covering the inner region of partition 16 that covers tub 14. Retaining ring 18 may be constructed of metal (e.g., stainless steel) or another suitable material. Retaining ring 18 may be removably secured to base 12. In the illustrated embodiment of FIG. 7, a plurality of apertures 20 are provided around the outer regions or rims of base 12 and retaining ring 18 to receive threaded fasteners 22 and nuts 23 therein. Other suitable fasteners include snaps or clasps, for example.

Between base 12 and retaining ring 18, one or more seals 24 (e.g., 0-rings) may be provided to isolate tub 14 from the surrounding environment, as shown in FIG. 3A. Specifically, seals 24 may prevent air or vapor in tub 14 from escaping between base 12 and retaining ring 18.

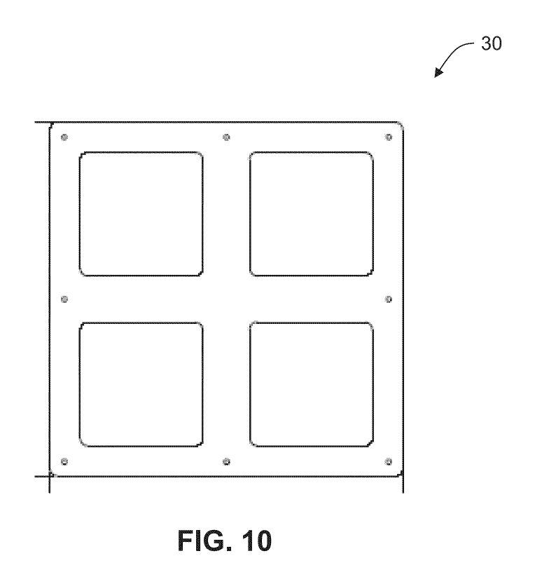

Sample holder 10 may include one or more liquid ports 26, as shown in FIG. 9. Sample holder 10 illustratively includes four liquid ports 26 for convenience, one on each corner of sample holder 10, as shown in FIG. 4. Each liquid port 26 extends through base 12 and into tub 14. When opened, each liquid port 26 may be used to fill tub 14 with a liquid sample or to drain a liquid sample from tub 14. Advantageously, these liquid filling and liquid draining operations may be performed without having to remove partition 16 from sample holder 10.

Sample holder 10 may also include one or more gas or bleed ports 28, as shown in FIGS. 8 and 8A. During a liquid filling operation, bleed port 28 may be opened to remove air from tub 14 beneath partition 16.

Sample holder 10 may further include one or more spacers 30 beneath base 12, as shown in FIGS. 3A and 10, to adjust the height of sample holder 10 in the alpha particle detector 100 (FIG. 13), as necessary. Spacer 30 may be constructed of the same material as base 12, such as a conductive, high density, UHMW plastic material. Like base 12, spacer 30 may interact with tray 106 to limit movement therebetween. For example, in the illustrated embodiment of FIG. 3A, both base 12 and spacer 30 receive the stabilizing post 107 from tray 106 to limit movement between base 12, spacer 30, and tray 106.

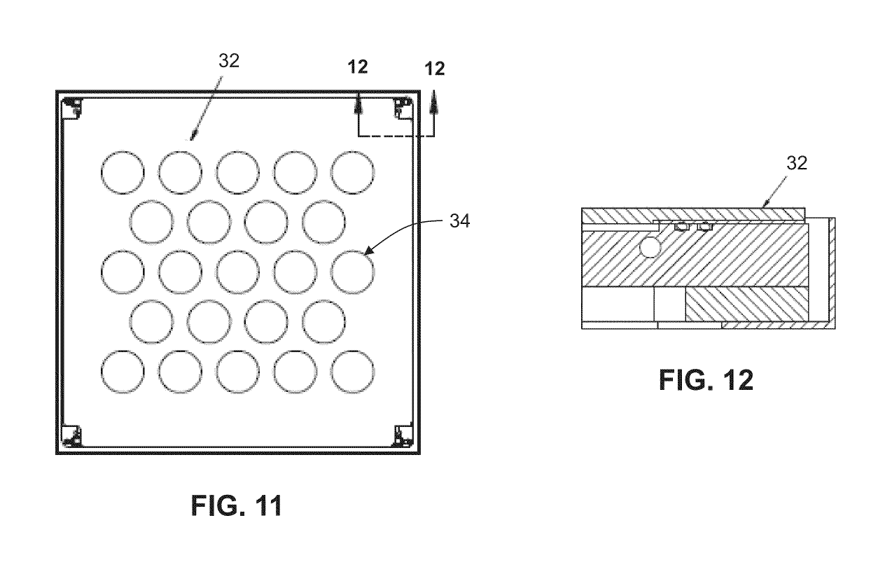

Sample holder 10 may further include a temporary support 32 for partition 16, as shown in FIGS. 11-12. The temporary support 32 may be constructed of a polycarbonate material or another suitable material. The temporary support 32 may be used to support partition 16 and prevent partition 16 from tearing during liquid filling operations, for example. A plurality of apertures 34 may be provided in support 32 to allow air to flow through support 32 when support 32 is being applied onto partition 16. The temporary support 32 may be removed during alpha particle detection so as not to interfere with the alpha-permeability of partition 16.

### Detector

The liquid sample is then tested for alpha particle emissions by placing the sample holder 10 in a direct alpha particle detector. An exemplary direct detector is a gas flow counter. A suitable gas flow counter includes a low background, large sample area gas flow counter, such as the UltraLo-1800 Alpha Particle Counter available from XIA LLC of Hayward, Calif.

The direct detector may be an ionization-type detector (i.e., an ionization chamber). An exemplary ionization-type detector 100 is shown schematically in FIG. 13. The illustrative detector 100 includes an active volume 102 filled with a high-purity counting gas (e.g., argon), a lower grounded support 104, and an upper pair of positively charged electrodes including a central anode 108 and a guard electrode 110 surrounding the central anode 108. The upper electrodes 108, 110, may be held at a positive voltage of 1000 V, for example. This arrangement produces an electric field between lower grounded support 104 and upper electrodes 108, 110. The upper electrodes 108, 110, are coupled to a controller 112 that is programmed to analyze current on the upper electrodes 108, 110.

The lower grounded support 104 may hold and support the sample tray 106, which contains the above-described sample holder 10 of FIGS. 1-12 and the liquid sample. By constructing at least the upper surface of partition 16, base 12, and sample tray 106 of conductive materials, partition 16 may communicate electrically with base 12, base 12 may communicate electrically with sample tray 106, and sample tray 106 may communicate electrically with the lower grounded support 104. In this arrangement, the upper surface of partition 16 may serve as a lower electrode that interacts with upper electrodes 108, 110, of detector 100.

In operation, when an alpha particle (a) emits from the liquid sample inside of the sample tray 106, the alpha particle (a) ionizes argon gas molecules in the active volume 102 to produce electron-ion pairs. The negatively charged electrons drift toward the positively charged electrodes 108, 110, and the positively charged argon ions drift toward the lower electrode, in this case the upper surface of partition 16. The electrodes 108, 110, absorb the electrons over time, which induces a current that is analyzed by the controller 112.

The direct detector may also be a proportional-type detector (i.e., a proportional chamber). Proportional-type detectors are generally similar to ionization-type detectors, but proportional-type detectors use fine diameter wire anodes to generate strong electric fields that are capable of creating electron “avalanches” and amplifying the signal through electron multiplication. Proportional-type detectors generate larger signals than ionization-type detectors.

The detector may output data indicative of the alpha particle emission levels of the liquid sample. The data may include alpha counts measured over time, alpha counts measured at different energy levels, total alpha counts, emissivity, and other data. This data may be presented in various formats, including charts, tables, lists, and other suitable formats.

Advantageously, the present disclosure provides an apparatus and an analytical method for detecting and measuring alpha particle emissions from liquid samples using direct detectors. The ability to test liquid samples allows for the detection of alpha particles over greater distances than solid samples for more accurate detection. Also, the ability to test liquid samples provides flexibility and breadth in selecting the sample medium. The ability to use direct detectors offers reduced background and improved sensitivity compared to indirect detectors. Thus, the present disclosure provides for improved accuracy, flexibility, and quality in detecting and measuring alpha particle emissions.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### Examples

The following non-limiting Examples illustrate various features and characteristics of the present invention, which is not to be construed as limited thereto.

### Working Example 1

### Alpha Particle Detection of a Dry Sample Through a Partition

A sample holder was loaded with thin sheets of a 99.99% pure tin material known to have an alpha particle emissivity of about 0.04 counts/hour/cm². The sample holder was then covered and sealed with a 6-micron thick sheet of an aluminized PP film.

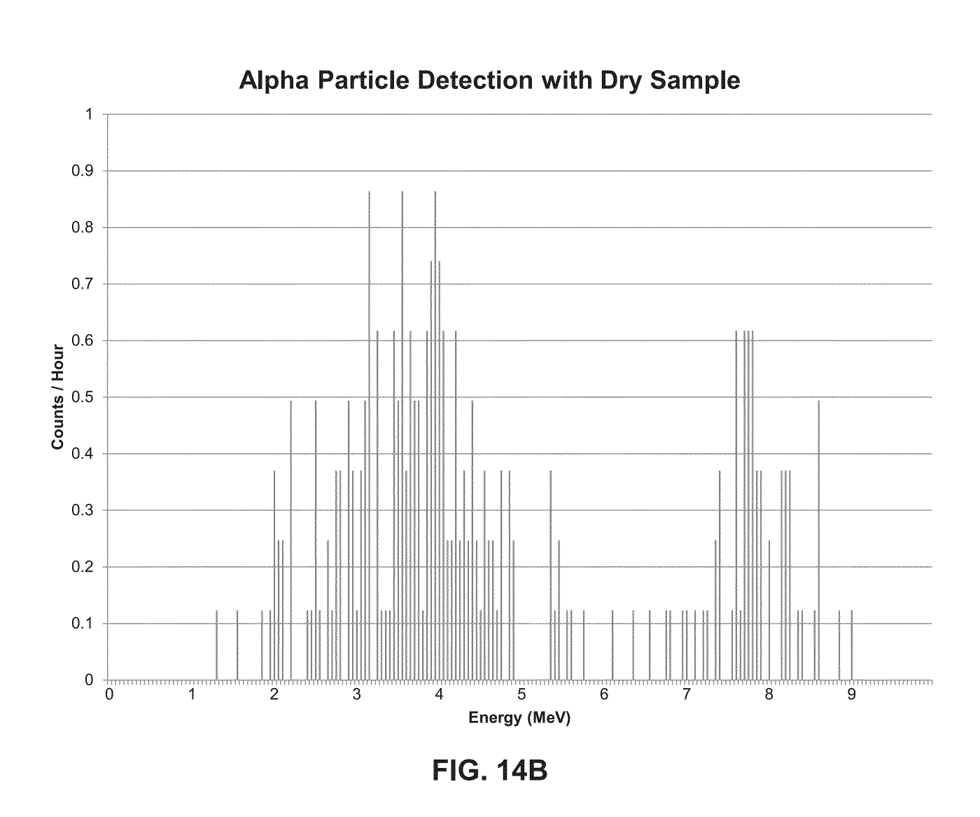

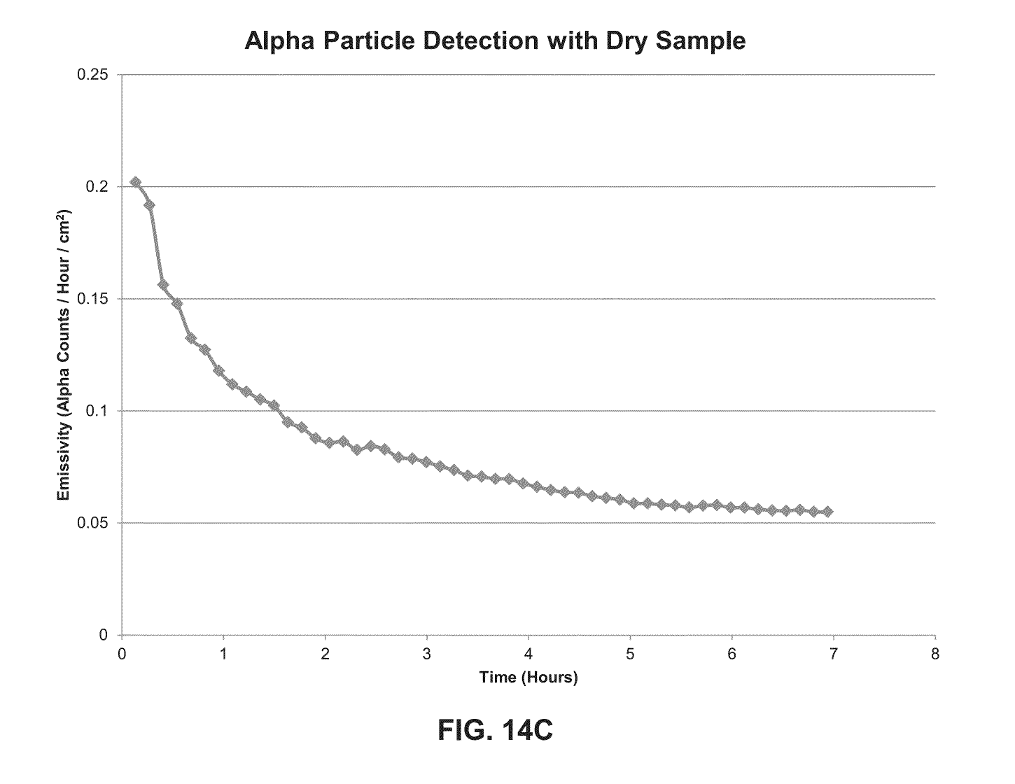

The partitioned sample holder containing the tin sample was then placed in the above-described UltraLo-1800 Alpha Particle Counter and subjected to alpha particle detection. As shown in FIGS. 14A-14C, alpha particles were detected through the partition, which evidences that the partition was an effective alpha-permeable membrane.

### Working Example 2

### Alpha Particle Detection of a Wet Sample Through a Vapor-Impermeable Partition

400 mL of deionized water was introduced beneath the partition of the sample holder with the tin from Example 1 using liquid ports in the sample holder.

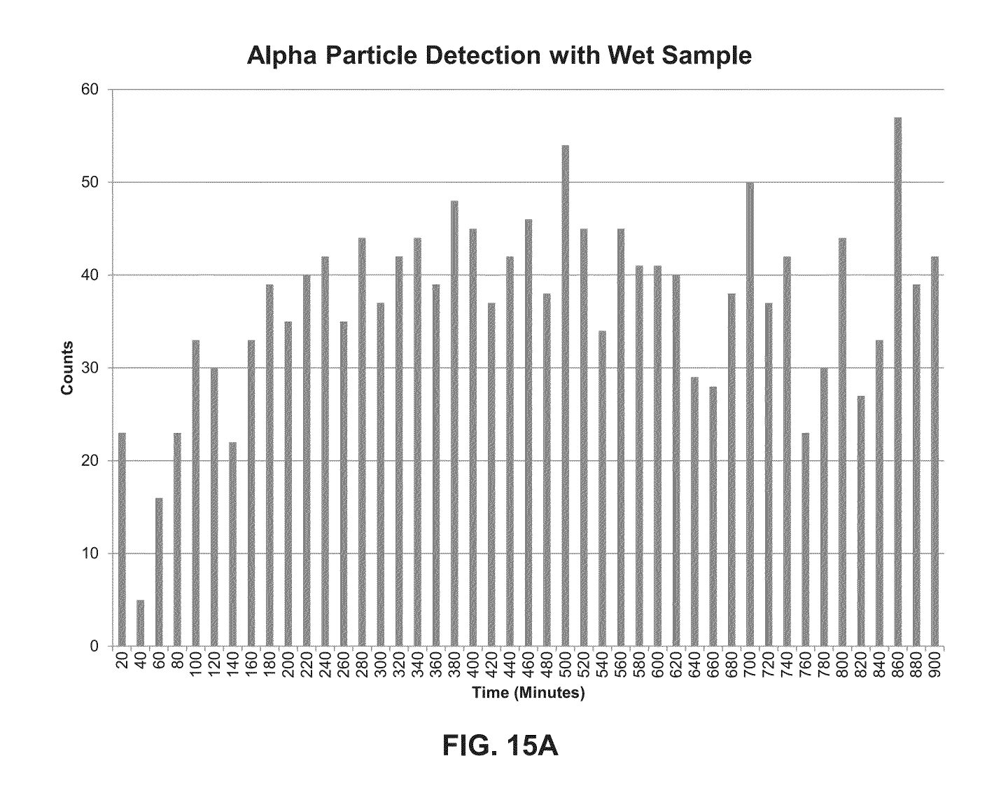

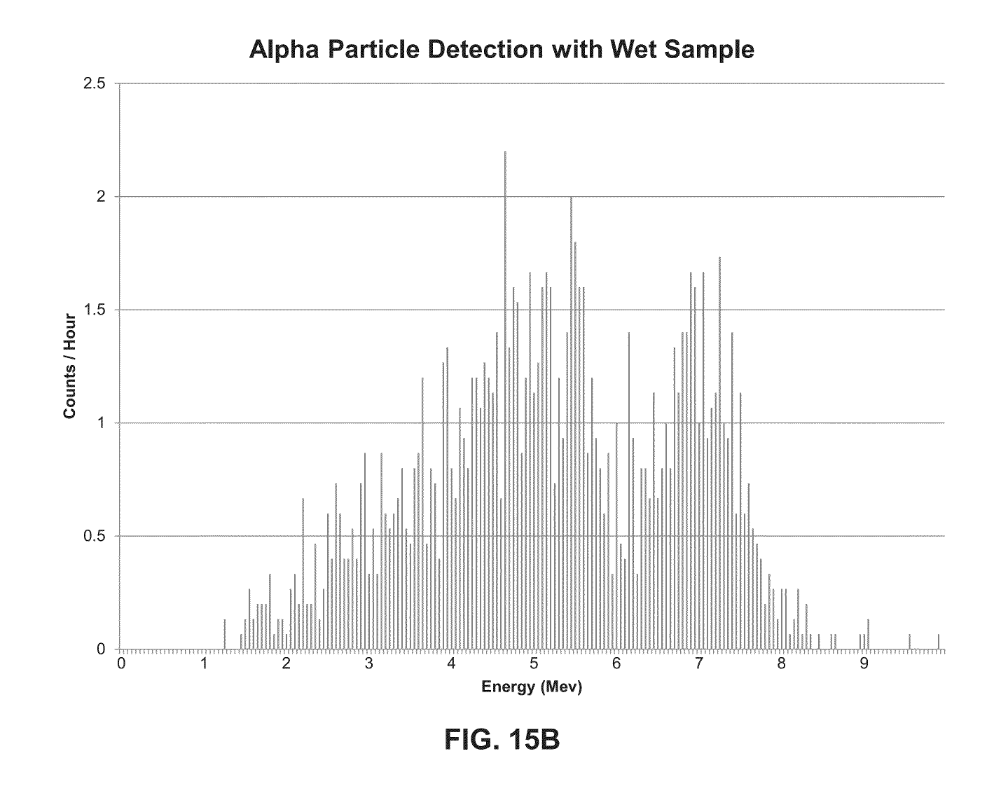

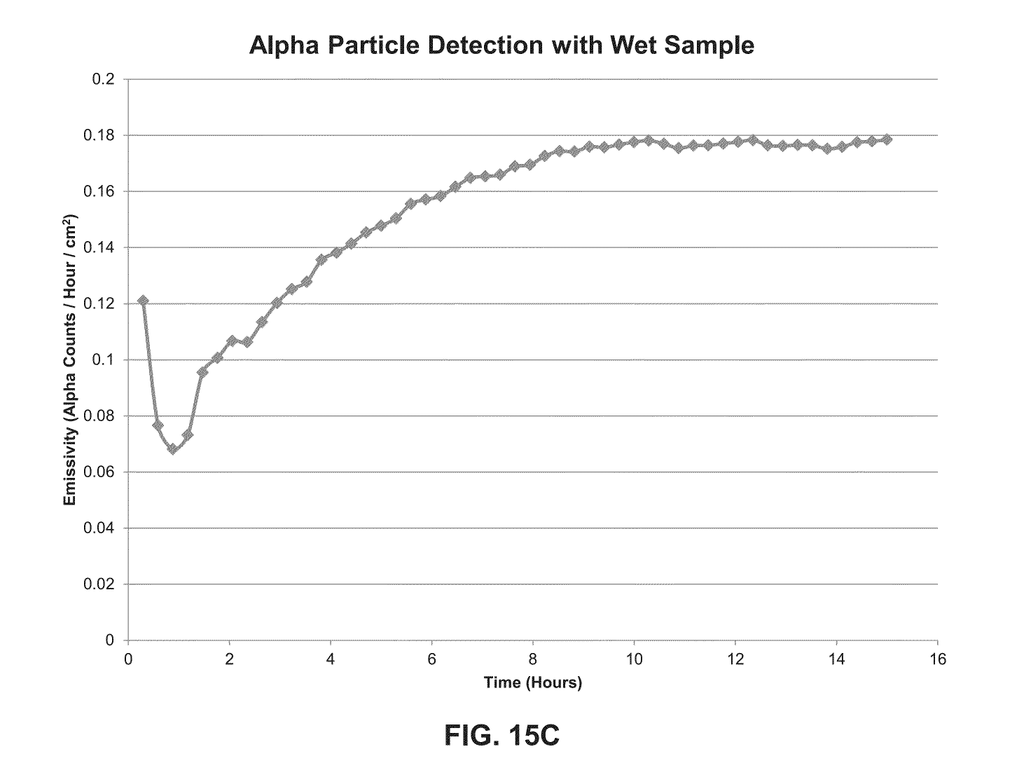

The partitioned sample holder with the tin and water was then placed in the above-described UltraLo-1800 Alpha Particle Counter and subjected to alpha particle detection. As shown in FIGS. 15A-15C, alpha particles were again detected through the partition, which further evidences that the partition was an effective alpha-permeable membrane. In fact, significantly more alpha particles were detected with the wet sample of Example 2 than with the dry sample of Example 1. This increase and the spectrum observed in Example 2 is consistent with radon contamination, specifically radon-222 (²²²Rn) and radon-220 (²²⁰Rn) contamination, which may have been deposited on the glassware used to transfer water into the sample holder.

As shown in FIG. 15C, alpha particle emissivity stabilized over time, which evidences that the partition was also an effective vapor-impermeable membrane. During an initial 3-hour testing period, it is believed that some water vapor may have been present in the detector, possibly due to the water that was spilled on the outside of the sample holder. After this initial 3-hour testing period, it is believed that the water vapor was purged from the detector without additional water vapor escaping into the detector through the partition. Had water vapor been able to escape into the detector through the partition, one would have expected the alpha particle counts to have monotonically decreased over time.

### Working Example 3

### Detection of Trace Uranium in Solution

Detection of trace alpha emitters in solution was demonstrated by introducing 550 mL of deionized water beneath the partition and subjecting the solution to alpha particle detection using a direct detector, specifically the above-described UltraLo-1800 Alpha Particle counter. The deionized water was stored in a sealed volumetric flask for 41 days prior to introduction into the tray assembly. Thus, any radioisotopes with half lives shorter than 10 days had substantially decayed away and did not contribute to the background signature of the sample. The spectrum obtained was consistent with the spectrum observed in Example 1, FIG. 15B, and the bulk alpha activity detected is displayed in Table 1 (labeled “blank deionized water”). The spectrum is consistent with ²²²Rn and ²²⁰Rn contamination as described in Example 2. Eliminating this source of background requires radiopure tray and partition materials as well as radiopure solvents used in the analysis. However, the detection of a background signal three orders of magnitude above the instrumental detection limit (˜0.0001 α/hr/cm²) is evidence of the sensitivity of the method. In order to realize that sensitivity in practice, it is necessary to minimize the background sources as described above.

After the water solution analysis above was completed, 50 mL of uranium nitrate solution was added to the 550 mL solution in the tray assembly and mixed well to form a U solution. The uranium nitrate concentration was 0.1 ppm in the 600 mL U solution. The uranium nitrate solution was made by diluting a 1000 ppm Uranium ICP standard (Ricca Chemical Company, Arlington, Tex.) to the desired concentration. The 0.1 ppm U solution was then subjected to alpha particle detection in the UltraLo-1800 Alpha Particle counter. The alpha emissivity attributable to 0.1 ppm uranium is determined by subtracting the blank deionized water alpha emissivity from the uranium nitrate alpha emissivity. For this example, the 0.1 ppm uranium nitrate yields an alpha flux of 0.0149 a/hr/cm².

TABLE 1

| | Total | Counting | Alpha | |
|---|---|---|---|---|
| | Volume | time | Emissivity | 1σ |
| Sample | (mL) | (hrs) | (α/hr/cm2) | Uncertainty |
| Blank deionized | 550 | 16.6 | 0.1116 | 0.005 |
| water | | | | |
| 0.1 ppm Uranium | 600 | 8.4 | 0.1265 | 0.003 |
| Nitrate | | | | |

What is claimed is:

1. A method of measuring an alpha particle emission level from a liquid sample, the method comprising the steps of:
placing the liquid sample in a holder having a partition, the partition being impermeable to vapor from the liquid sample and permeable to alpha particles from the liquid sample; and
using a detector to measure the alpha particle emission level of the liquid sample.

2. The method of claim 1, wherein the detector is a direct detector that measures electrical charge created from radiation interactions in an active volume of the detector.

3. The method of claim 2, wherein the detector is an ionization-type detector.

4. The method of claim 2, wherein the detector is a proportional-type detector.

5. The method of claim 1, wherein the liquid sample comprises a metallic material in a liquid solvent.

6. The method of claim 5, wherein the liquid sample is dissolved in the liquid solvent.

7. A sample holder for use with an alpha particle detector, the sample holder comprising:
a base that defines a tub for receiving a liquid sample, the base being sized for receipt in the alpha particle detector; and
a partition located between the tub and the alpha particle detector, the partition being impermeable to vapor from the liquid sample in the tub and permeable to alpha particles from the liquid sample in the tub.

8. The sample holder of claim 7, wherein both the base and the partition are electrically conductive.

9. The sample holder of claim 7, wherein the partition comprises a metalized polymer film.

10. The sample holder of claim 7, wherein the partition comprises graphene.

11. The sample holder of claim 7, wherein the partition has a thickness of about 10 microns or less.

12. The sample holder of claim 11, wherein the partition has a thickness of about 6 microns or less.

13. The sample holder of claim 7, further comprising at least one port that extends through the base to direct the liquid sample into the tub.

14. The sample holder of claim 7, further comprising a retaining ring that extends around a rim of the base to support the partition.
